(19) United States
(12) Patent Application Publication
(10) Pub. No.: US 2007/0237874 A1
(43) Pub. Date: Oct. 11, 2007

(54) Food gels comprising an indigestible or poorly digestible carbohydrate and related methods of forming the same

(76) Inventor: Allan W. Buck, Decatur, IL (US)

Correspondence Address: KIRKPATRICK & LOCKHART PRESTON GATES ELLIS LLP;HENRY W. OLIVER BUILDING, 535 SMITHFIELD STREET, PITTSBURGH, PA, 15222, US

(21) Appl. No.: 11/732,843

(22) Filed: Apr. 5, 2007

Related U.S. Application Data
(60) Provisional application No. 60/789,780, filed on Apr. 6, 2006.
(60) Provisional application No. 60/872,250, filed on Dec. 1, 2006.

(51) Int. Cl. A23L 1/05

(52) U.S. Cl. 426/573

(57) ABSTRACT

Methods and compositions are provided herein directed to a food gel, comprising an indigestible or poorly digestible carbohydrate-containing ingredient. The carbohydrate-containing ingredient may be a highly branched soluble fiber, such as Fibersol-2. The Fibersol-2 may also provide anti-caking properties to the dry mix. Methods are also provided herein for producing good gels with increased dietary fiber content.

### CROSS-REFERENCE TO RELATED APPLICATIONS

This application claims the benefit of U.S. Provisional Application No. 60/789,780, filed on Apr. 6, 2006, and U.S. Provisional Application No. 60/872,250, filed Dec. 1, 2006, the entire teachings of which are incorporated herein by reference.

### TECHNICAL FIELD

Food gels comprising an indigestible or poorly digestible carbohydrate, and related methods of forming the same.

### BACKGROUND

Gel food products (generally, “food gels”), such as gelatin, have been commercially produced for hundreds of years. Food gels are thought to have originated from the discovery that boiling the bones, connective tissue, and/or skin of animals killed for food produced a substance that was liquid when hot, but which solidified when cooled. Accordingly, many food gels contain a significant amount of protein-containing ingredients. For example, typical protein-containing ingredients contained in gelatin include naturally occurring protein collagen. Even though gelatin contains nine essential amino acids, gelatin is an incomplete nutritional protein because it lacks tryptophan, an essential amino acid. Accordingly, most gelatins have little nutritional value apart from providing energy from calories.

Food gels, such as gelatin, have also been found to contain distinctive functional properties due to their rod-shaped chemical structure, known as proto fibril. Structurally, collagen is composed of three polypeptide chains that are wound together into an α-helix and held together by hydrogen bonding. Collagen chains are also cross-linked by covalent bonds. Gelatin molecules consist principally of repeating sequences of glycine-proline-hydroxyproline triplets, and bonding occurs at points along these strands, forming pockets that trap large amounts of liquid, resulting in a semisolid colloid. All colloids have a disperse phase and a continuous phase. In gelatin products, the disperse phase is solid gelatin and the continuous phase is, typically, water. In this form, gelatin can absorb up to 10 times its weight of water. In addition, food gels exhibit a range of viscosities, firmness, texture, and gel strength, such as those properties exhibited by various commercially recognizable products that include Jell-O® brand gelatin, a registered trademark of Kraft Food Holdings, Inc., marshmallows, and “gummi bears.” Gelatin also can act as an emulsifier, stabilizer, or thickener in non-food gel products such as ice cream, sour cream, jellies, and cake frostings, when added to these products in small amounts. For example, U.S. Pat. No. 5,472,732 to Ohkuma et al. discloses the use of indigestible dextrins that can be added to jellies having a relatively small amount of gelatin therein so that the non-food gel composition has some degree of firmness, but is still readily spreadable.

Because of the commercial success of various food gels, efforts have been made to provide additional food gel options that appeal to a wider variety of taste experiences and/or health interests of consumers. For example, food gels having a wide range of flavors, gel hardness, and textures have recently been introduced. Sugar-free products have also been developed to appeal to those consumers interested in a lower calorie alterative to sugar-containing gelatins. In addition, numerous food, such as dessert, recipes have been introduced to encourage the consumption of food gels.

Accordingly, there is a continued need to provide additional food gels products having characteristics that promote health incentives and/or encourage consumer consumption.

### SUMMARY

The present disclosure addresses the above-mentioned need by providing a food gel comprising a gel forming material present in an amount sufficient to form a food gel matrix, and an indigestible or poorly digestible carbohydrate-containing ingredient.

In another embodiment, the present disclosure provides a food gel comprising a gel forming material present in an amount sufficient to form a food gel matrix, and an amount of Fibersol-2 effective to provide increased dietary fiber content in the food gel relative to a food gel not comprising an amount of Fibersol-2.

In another embodiment, the present disclosure provides a food gel, comprising: a gelatin in an amount of at least 6% by dry weight; adipic acid; Fibersol-2; optionally, a sweetening agent; optionally, disodium phosphate; optionally, maltodextrin; and optionally, fumaric acid.

Also provided is a method of forming a food gel mixture, comprising adding an indigestible or poorly digestible carbohydrate-containing ingredient to a food gel composition to form the food gel mixture.

In another embodiment, the present disclosure provides a method of forming a gelatin mixture, comprising adding an amount of Fibersol-2 to a gelatin to form the gelatin mixture.

Also provided is a method of forming an anti-caking dry mix, comprising adding a sufficient amount of Fibersol-2 to a dry mix.

Also provided is a dry mix containing an anti-caking agent, the anti-caking agent comprising Fibersol-2.

It should be understood that this invention is not limited to the embodiments disclosed in this Summary, and it is intended to cover modifications that are within the spirit and scope of the invention, as defined by the claims.

### DETAILED DESCRIPTION

Other than in the operating examples, or unless otherwise expressly specified, all of the numerical ranges, amounts, values and percentages, such as those denoting amounts of materials, times and temperatures of reaction, ratios of amounts, and others in the following portion of the specification, may be read as if prefaced by the word “about,” even though the term “about” may not expressly appear with the value, amount or range. Accordingly, unless indicated to the contrary, the numerical parameters set forth in the following specification and attached claims are approximations that may vary depending upon the desired properties sought to be obtained by the invention. At the very least, and not as an attempt to limit the application of the doctrine of equivalents to the scope of the claims, each numerical parameter should at least be construed in light of the number of reported significant digits and by applying ordinary rounding techniques.

Notwithstanding the fact that the numerical ranges and parameters setting forth the broad scope of the invention are approximations, the numerical values set forth in the specific examples are reported as precisely as possible. Any numerical values, however, inherently contain certain errors necessarily resulting from the standard deviation found in their respective testing measurements. Furthermore, when numerical ranges of varying scope are set forth herein, it is contemplated that any combination of these values inclusive of the recited values may be used.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10. In addition, the terms “one,” “a,” or “an” as used herein are intended to include “at least one” or “one or more,” unless otherwise indicated.

Any patent, publication, or other disclosure material, in whole or in part, that is identified herein is incorporated by reference herein in its entirety, but is incorporated herein only to the extent that the incorporated material does not conflict with existing definitions, statements, or other disclosure material set forth in this disclosure. As such, and to the extent necessary, the disclosure as explicitly set forth herein supersedes any conflicting material said to be incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

The present disclosure provides various features and aspects of the exemplary embodiments provided herein. It is understood, however, that the present disclosure embraces numerous alternative embodiments, which may be accomplished by combining any of the different features, aspects, and embodiments described herein in any combination that one of ordinary skill in the art may find useful.

Products and their related methods are provided herein for increasing the dietary fiber content of food gels while substantially maintaining at least one of flavor, mouthfeel, gumminess, and clarity of the food gel. The products and methods provided herein include adding an indigestible or poorly or slowly digestible carbohydrate to the food gel formulation. In certain embodiments, the indigestible or poorly digestible carbohydrate is a highly branched carbohydrate, such as Fibersol-2.

In certain embodiments of the present teaching, it has been found that the addition of certain indigestible or poorly digestible carbohydrates to food gels, such as gelatin, increase the health benefits associated with the consumption of the food gel, but do not adversely affect gel properties, such as strength and/or structure, and/or the taste experience associated with food gel products, such as flavor, mouthfeel, gumminess, and clarity. In certain embodiments, it has been found that effective amounts of indigestible or poorly digestible carbohydrates provide health benefits, such as dietary fiber fortification, but do not increase the level of soluble components that could adversely affect gel properties.

As used herein, the term “food gel” refers to a food product that, at its normal serving conditions, is a colloid in which the disperse phase has combined with a continuous phase and, unlike conventional jellies or jams, comprises a sufficient amount of gel forming material to form a “food gel matrix” which is a viscous and translucent product that retains it shape when molded and set, and has a matrix structure such that is can be cut into various shapes, such as cubes, following formation. Suitable gel forming materials include, for example, gelatin, pectin, konjac flour, starch gels, alginates, carrageenan, gellan, protein gels, agar, and combinations of any thereof. It is contemplated that the gel forming material may include gelatins that may be obtained by hydrolysis of collagen produced from boiling the bones, connective tissue, and/or skin of animals. In certain embodiments, the gelatin may be present in the food gel in any suitable amount sufficient for shape retention, such as, for example, at least 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, and 40% by weight on a dry weight basis. The food gel may be, for example, commercially available gelatins products, such as Jell-O® brand gelatin, and can include either sugar-added or sugar-free gelatin products. One of ordinary skill in the art will recognize the physical characteristics of Jell-O® gelatin products, and it is essentially these characteristics that certain embodiments of the present disclosure display. In other embodiments, the food gel may include starch jellies and pectin jellies. Food gels may be prepared from a mixture of ingredients, the mixture, as its normal serving conditions, capable of being molded, formed or cut into, and can retain, various cross-sectional configurations, for example and without limitation, a square, a circular, a generally semi-circular, a rectangular, or a trapezoidal configuration.

When the gel forming material comprises gelatin, the gelatin may be present in the food gel in amounts sufficient to form a food gel matrix and provide the appropriate physical characteristics to the food gel as described herein. In certain embodiments, the gelatin may be present in the food gel in amounts ranging from at least 6% by dry weight, and in certain embodiments at least 9% by dry weight, inclusive of the indigestible or poorly digestible carbohydrate containing ingredient set forth hereinbelow, particularly as these embodiments relate to sugar-added products. In other embodiments, the gelatin may be present in the food gel in amounts ranging from at least 15% by dry weight, and in certain embodiments at least 20% by dry weight, inclusive of the indigestible or poorly digestible carbohydrate containing ingredient set forth hereinbelow, particularly as these embodiments relate to sugar-free products.

Generally, the food gel, as described herein, comprises one or more indigestible or poorly digestible carbohydrate-containing ingredients. As used here the terms “indigestible carbohydrate,” “poorly digestible carbohydrate,” and “carbohydrate-containing ingredient” refer to carbohydrate moieties that are resistant to endogenous digestion in the human upper digestive tract. In certain embodiments, the indigestible or poorly digestible carbohydrate carbohydrate-containing ingredient may be characterized as having a suitable degree of polymerization, a suitable molecular weight, a suitable dextrose equivalent (DE), and may be heat and pH stable. In other embodiments, the indigestible or poorly digestible carbohydrate-containing ingredient may be characterized as being resistant to digestion in the upper GI tract, and may include, for example, polydextrose, tagatose, Nutriose®, a registered trademark of Roquefte Freres, Lestrem, France, inulin, fructooligosacchairde, isomaltooligosaccharide, some polyols (sugar alcohols), and combinations of any thereof. AOAC 2001.03 defines fiber for resistant maltodextrin as those components remaining after treatment with dietary enzyme that are DP3 (i.e., degree of polymerization with 3 polymeric units) or higher in chain length. Inulin, FOS, IMO, polydextrose have their own published tests, which are know to those of ordinary skill in the art. Some of the polyols and tagatose compounds are less than DP3 but are resistant to digestion and so have some fiber-like qualities. One commercial embodiment of the indigestible or poorly digestible carbohydrate-containing ingredient, as set forth herein, is a low molecular weight indigestible dextrin sold under the tradename Fibersol-2, distributed by Matsutani Chemical Industry, Hyogo, Japan. Indigestible or poorly digestible carbohydrates possess many of the characteristics of total dietary fiber. However, they are not necessarily quantifiable by the American Association of Cereal Chemists (AACC) Method 32-07 for determining fiber content and, consequently, they may not be included in dietary fiber totals. The indigestible or poorly digestible carbohydrate-containing ingredient may be used to add dietary fiber to the finished product. Some ingredients may contain more than one constituent, for instance.

The indigestible or poorly digestible carbohydrate-containing ingredient as set forth herein may include, for example, Fibersol-2, Nutriose, xylose, xylitol, sorbitol, cyclodextrins, trehalose, raffinose, stachyose, fructooligosaccharide, polydextrose, maltose, pectins, gums, carrageenan, inulin, hydrogenated indigestible dextrins, hydrogenated starch hydrolysates, highly branched maltodextrins, cellulose, and mixtures of any thereof. In certain embodiments, the indigestible or poorly digestible carbohydrate of the present disclosure may be a highly branched soluble fiber. These polymers are only partially metabolized in the human body. Most of the product passes through the body unabsorbed, and the principal utilization pathway for the remainder involves metabolism by intestinal micro-organisms to form carbon dioxide and volatile fatty acids. Those acids may then be absorbed and utilized as an energy source.

The term “dietary fiber” refers to the sum of the soluble and insoluble fibers. These food components are not broken down by the alimentary enzymes of humans to small molecules, and are not absorbed into the bloodstream.

“Soluble fiber” refers to a carbohydrate that is not absorbed, or is only slowly or partially absorbed, in the human gut. Such carbohydrates are called “soluble” fiber because of their solubility and low absorption. Examples of soluble fiber include fructooligosaccharides, arabinogalactan, modified starches, cellulose compounds, such as methylcellulose and ethylcellulose, and naturally-occurring soluble fibers such as inulin, psyllium husk and glucomannan. Natural gums such as gum arabic, carrageenan, guar gum, locust bean gum, xanthan gum and pectin are also naturally-occurring sources of soluble fiber. Gums are usually added to food products at a rate of 1% or less, but this can be increased according to the invention described herein. Generally, natural gums such as gum arabic, carrageenan, guar gum, locust bean gum, xanthan gum and pectin affect the texture and viscosity such that these components typically are not added to a gelatin or Jell-O®-type product, although these components may be used in other gel products. In certain embodiments, the amounts needed to make a gel are at a level such that these components may not provide a nutritional benefit. Other soluble fibers also provide high viscosity, such as, for example, psyllium and beta glucan.

Inulins are heterogeneous β(2-1) fructans, and are polymers of fructose units, usually terminating in a glucose. The linear fructose polymers are linked by β(2-1) bonds. The terminal glucose units are linked by an α(1-2) bond. Inulin is major storage food in the roots of members of the Compositae, such as dandelion, elecampane, chicory, Jerusalem artichoke and the Chinese herb codonopsis, and also in leek and asparagus. Inulin has a mildly sweet taste, but is not substantially digested or absorbed when taken orally, and sometimes is used as a constituent in food formulations for diabetics for this reason. Inulin is fermented by lactobacilli such as Lactobacillus bifidobacteria in the bowel and is used to maintain populations of intestinal microflora and increase gut health. Lactobacilli digest inulin, producing short chain fatty acids including acetic acid, propionic acid and butyric acid. There is some evidence that inulin and butyric acid can prevent cancer and pre-cancerous changes in the colon, and inulin therefore can be viewed as a desirable functional food ingredient in its own right.

Glucomannan is isolated from the tuber of the konjac plant, and is the most viscous of the naturally-occurring soluble fibers, and has the highest water-holding capacity.

“Highly branched carbohydrate” refers to a carbohydrate in which the glycosidic linkages have been randomized to the extent that those linkages are indigestible or are only partially digestible by conventional amylases and glucosidases. Such highly branched carbohydrates can be produced by treatment of starch with heat, acids or enzymes.

Modified starches are one form of soluble fiber that is not digested, or is digested at a low rate. Starch, including straight and branched-chain starches, can be modified to change its rate and degree of digestion in the small intestine. Partial hydrolysis of starch using combinations of enzymes, heat and/or acid can result in molecular rearrangement of the starch molecule so that alpha and beta-(1,2) and -(1,3) linkages are formed, and alpha-(1,4) and -(1,6) bonds are changed into beta bonds. To make such a modified starch, corn starch can be treated in this way to produce a low molecular weight indigestible dextrin (e.g., “Fibersol-2(E)”, “Fibersol-2” and “Fibersol” are intended to be synonymous). Such a resistant maltodextrin has a slow rate of fermentation and is more likely to reach the lower part of the large intestine and be digested by lactobacilli.

Therefore, in speaking of “soluble fiber”, “highly branched carbohydrate”, and “indigestible carbohydrate” or “poorly digestible carbohydrate”, it is to be understood that these classes are not mutually exclusive, that is, some individual compounds may fall into more than one of these classes. For instance, the compound sold under the trade name “Fibersol-2” is a soluble fiber and also is highly branched. Due to its highly branched structure and relatively low number of alpha 1-4 linkages, it also is indigestible or poorly digestible.

The carbohydrate-containing material may be added in any form, such as a solid, as dry material, or as a slurry solution. In certain embodiments, the carbohydrate-containing ingredient is dry blended with the food gel.

Any reference to a quantity of carbohydrate should be understood as referring to the actual carbohydrate content within the carbohydrate-containing ingredient. For example, Fibersol-2, in “dry” powdered form, typically includes a moisture content of approximately 5.0% by weight. Accordingly, if it is desired to provide a food gel containing Fibersol-2 having a dietary fiber amount of 2.5 grams/serving, the addition of approximately 2.7 to 2.9 grams/serving of “dry” powdered Fibersol-2 would be necessary.

In general, DE correlates with the sweetness intensity of the component. For example, low DE corn syrup (i.e., Dextrose Equivalent corn syrup) refers to a corn syrup of a lower sweetness intensity due to its being high in maltose and other higher saccharides that does not taste as sweet as fructose or sucrose. These are usually preceded by a number that refers to the dextrose equivalent. In general, the higher the dextrose equivalent, the sweeter the component. For example, “42DE” corn syrup would have a relative sweetness 45 to 50% of that of sucrose. A corn syrup designated as 62/43 will have a Dextrose Equivalent (DE) of 62 and a Baume reading at 100° F. (38° C.) of 43. The sugar profile can consist of glucose (dextrose) 36%, maltose 31%, trisaccharides 13% and higher saccharides 20%. It would have a relative sweetness 60 to 70% of that of sucrose. The relative sweetness of the sugars is given as: sucrose: 1.0; glucose: 0.5 to 0.6; fructose: 1.4; maltose: 0.3. The sweetness intensity of corn syrup is further lowered by lowering the corn syrup's original Brix from about 82 Brix to as low as about 40 Brix, in some cases by diluting with water.

The indigestible or poorly digestible carbohydrate may be added to the food gel in amounts sufficient to increase dietary fiber in the consumer when consumed, and may range from 0.5 grams/serving to 7.5 grams/serving, in some embodiments may range from 1.0 grams/serving to 5.0 grams/serving, in other embodiments may range from 2.0 grams/serving to 5.0 grams/serving, and in other embodiments may range from 2.5 grams/serving to 4.0 grams/serving (values based on a 2500 kcal/day diet). It was found that embodiments that include 2.5 grams/serving of indigestible or poorly digestible carbohydrate exhibited excellent gel properties. In the United States, fiber claims exist for 2.5, 5.0, or higher than 5.0 grams per serving of food. Typically if one has a high fiber claim (i.e., greater than 5 grams/serving) the manufacturer does not supplement the food at higher levels. On the other hand, many of these indigestible materials serve a prebiotic function and very high levels could be used (100 grams per serving is possible) to provide a prebiotic benefit. In embodiments where the gel product is a Jell-O® brand product, the amount of indigestible or poorly digestible carbohydrate present may be in amounts of 81.5% in sugar free products, and 12% in sweetened products prior to adding the water. The amount of ingredient added for a fiber claim is adjusted based on the fiber content, i.e., Fibersol could be added at 2.75 grams, as is, or 2.6 grams, carbohydrate basis, so that 2.5 grams fiber are incorporated per serving if the fiber content is 95% dry basis and moisture is 4%.

The food gel can include solid material, that is, material that is not present as a homogeneous mass, such as, without limitation, whole or chopped nuts, grains, confectionary pieces (such as, but not limited to, chocolate pieces or chips), or substitutes thereof (such as, but not limited to, sugar-free confectionary pieces, carob, yogurt), or fruit, including dried, preserved or candied fruit or fruit paste, or extruded protein pieces in the form of flakes, granules, nuggets, or combinations of any thereof.

The food gels can be coated or enrobed, such as, and without limitation, with chocolate, including dark, light, milk or white chocolate, carob, yogurt, other confections, nuts, grains, or sugars, such as monosaccharide sugars. The coating can be a compounded confectionary coating or a non-confectionary (e.g., sugar free) coating. The coating can be smooth, or can contain solid particles or pieces.

Vitamins, minerals and other beneficial nutrients also can be added to the food gel, including functional ingredients, that is, ingredients intended to produce specific benefits to a person consuming the food gel. Examples of functional ingredients include, without limitation, omega-3 fatty acids, isoflavones, sterols and beta-carotene. Such functional ingredients can be included in the form of plant extracts or concentrates. For instance, omega-3 fatty acids can be added to the food gel formulation by adding flax flour or linseed oil. Isoflavones can be added by including soy flour or a more concentrated ingredient such as NovaSoy (Archer Daniels Midland, Decatur, Ill., USA). Beta-carotene can be added as a vitamin, or as carrot pieces or juice.

In certain embodiments, the food gel also may include additives such as, but not limited to, flavorings, natural or artificial sweetening agents, such as, for example, sugar or aspartame, colorings, emulsifiers, preservatives and other ingredients intended to achieve a particular flavor, color, texture and shelf life. Additives also are added to ease manufacturing, such as to ease the formation of the product. Some ingredients can be included that perform more than one of these functions.

Before, during, or after processing, the food gel may be placed in a suitable container and wrapped in a suitable food-grade wrapping, such as, but not limited to, air-tight foil or plastic wrapping.

In certain embodiments, the food gel may be made from ingredients, which are components which are combined together in accordance with a recipe or formulation. Ingredients may be altered or re-formulated during the preparation of the food gel, and may be listed on the packaging of the finished product.

In certain embodiments, the food gel of the present disclosure may be formed from ingredients typically found in Jell-O® brand products, including gelatin, which may be present in an amount of at least 6% by dry weight, adipic acid, optionally, a sweetening agent, such as sugar or aspartame, optionally, disodium phosphate, optionally, maltodextrin, and optionally, fumaric acid. The indigestible or poorly digestible carbohydrate ingredient, such as Fibersol-2, may be added to the dry mix or during manufacture.

The present disclosure also provides methods of forming a food gel mixture. The methods comprise adding an indigestible or poorly digestible carbohydrate-containing ingredient, as set forth herein, to a food gel composition, as described herein, having an amount of gel forming material to form the food gel mixture. The gel forming material may comprise gelatin, in amounts as set forth herein. Combining the carbohydrate-containing ingredient with the food gel composition can be accomplished by any manner know in the art, such as by dry blending. Once prepared, as described herein, such as by the addition of an aqueous solution, such as hot water, the mixture may be cooled to set. The food products may be prepared from the mixture and consumed as a stand-alone product, or may be incorporated into various conventional food products, such as, for example, Jell-O® salad, marshmallows, bakery products, gummi bears, and the like.

Food gel embodiments of the present disclosure comprising the carbohydrate-containing ingredient provide increased dietary fiber content of the food gel relative in a food gel not comprising the indigestible or poorly digestible carbohydrate. It was found that increasing the solids content of the food gel by the addition of indigestible or poorly digestible carbohydrates, such as Fibersol-2, inulin, polydextrose, and the like, in basic food gel formulations increases the indigestible fiber content without adversely affecting the gel properties or structure or the taste experience of the consumer. In certain embodiments set forth herein, food gels having an increased solids content that may be, for example, twice or greater the solids content by the addition of indigestible or poorly digestible carbohydrate relative to food gels that do not include the indigestible or poorly digestible carbohydrate had little or no adverse effect on gel strength. This was found to be true for both sugar-free and sugar-containing food gels. In the case of sugar-containing food gels that already contained a significant amount of soluble material, the addition of solids from an indigestible or poorly digestible carbohydrate source to the polysaccharides was found not to negatively impact gel strength.

As shown in the Examples, below, the addition of effective amounts of indigestible or poorly digestible carbohydrate, such as Fibersol-2, permits the incorporation of more soluble fiber into the food gel to increase dietary fiber content therein without sacrificing, for example, gel strength, gel structure, and/or gel set (i.e., gelatinization). As set forth in the Examples, Fibersol-2, as well as other indigestible or poorly digestible carbohydrates, exhibited at least acceptable, and, in some cases, exceptional gel properties and a superior taste experience to food gels. For example, clarity and firmness were not altered. It was also found that the addition of the carbohydrate-containing ingredient, such as Fibersol-2, adds bulk to sugar-free dry mixes, making scaling accuracy better and, consequently, provide better consistency.

As provided herein, it has been found that the addition of an indigestible or poorly digestible carbohydrate into food gels according to the teachings of the present disclosure increases amounts of dietary fiber in the food gel with little or no adverse affects to the properties of the food gel or to the taste experience of the consumer. The added fiber provides some nutritional value to the food gel, which is a benefit to all populations. In addition, certain populations, such as the diabetic population, who are large consumers of sugar-free gelatin desserts and who are encouraged to increase fiber content in their diets, can obtain particular benefits from embodiments of the present disclosure. It was found that food gels, such as gelatin desserts, at significant levels of fiber are indistinguishable in quality from conventional, non-supplemented food gels in both sugar-free and sugar versions. Sweetness, color, flavor were found not to be masked and do not have to be increased, even in sugar-free varieties. As set forth in the examples, food gels produced by incorporation of Fibersol-2 at effective levels in both sugar-free and sugar-containing (e.g. “regular”) packaged products were indistinguishable from that of control gels. Fibersol outperformed inulin in this testing in the areas of gel hardness, flavor/mouthfeel, gumminess (regular product only) and clarity (for the regular product). Fibersol outperformed polydextrose in the areas of gel firmness, flavor/mouthfeel (sugar-free only) and clarity (regular product only). Gels containing added maltodextrin (CR10) were rated as inferior based upon sensory differences from control (texture/mouthfeel), gumminess (regular product only) and clarity (regular product only). Sucrose was rated inferior-based upon flavor/texture/mouthfeel differences from control, gel hardness and gumminess (regular product only). It was found that relative to Fibersol, other soluble fiber sources, such as inulin, tend to hydrolyze under preparation conditions. It was also found that Fibersol did not mask the flavor of the Jell-O® product or its color intensity. Accordingly, the food gel products containing Fibersol gave the best overall results of the products tested.

In addition, it has been found that the addition of an indigestible or poorly digestible carbohydrate, such as Fibersol, to dry mixes in amounts as set forth herein might serve as an anti-caking agent therein. This could be a significant advantage in storing and handling dry mix desserts, beverages, and the like. Citric is omitted from dry mix products, such as Jell-O®-type, because it tends to absorb moisture, requiring more expensive acidulants and anti-caking agents to be added. The addition of Fibersol-2, for example, in dry mixes might permit the use of citric in these products.

Certain embodiments will be described further by reference to the following examples. The following examples are merely illustrative and are not intended to be limiting. Unless otherwise indicated, all parts are by weight.

### EXAMPLES

### Example 1

A control sample comprising Jell-O® sugar-free brand gelatin and a sample employing a mixture of Jell-O® sugar-free brand gelatin and Fibersol-2 were tested. The Jell-O® brand gelatin was prepared by following the recipe provided on the packaging. Using the instructions provided on the packaging (4 servings/packet), 11 g of Fibersol was added to the box mix to obtain approximately 2.5 g/serving fiber (2.75 g/serving Fibersol). One cup of boiling water was added to dissolve the gelatin, followed by mixing and the addition of one cup of cold water. After thoroughly mixing the ingredients, the control sample and the sample containing Fibersol were chilled until set. Following set, the samples were tested for hardness, adhesiveness, springness, gumminess, chewiness, and resilience, and exhibited the following properties:

TABLE 1
Properties of Jell-O ® control sample and Jell-O ® sample containing
Fibersol-2.

| | | Adhesiveness | | | | | |
|---|---|---|---|---|---|---|---|
| Test ID | Hardness G | g · sec | Springiness | Cohesiveness | Gumminess | Chewiness | Resilience |
| SF Jell- | 890.673 | −570.232 | 0.296 | 0.146 | 131.415 | 39.563 | 0.019 |
| O ® | | | | | | | |
| Control | | | | | | | |
| Avg | | | | | | | |
| Std Dev | 97.520 | 85.793 | 0.024 | 0.026 | 32.423 | 12.396 | 0.003 |
| SF Jell- | 867.299 | −675.619 | 0.327 | 0.234 | 202.571 | 67.259 | 0.026 |
| O ® w/ | | | | | | | |
| Fibersol | | | | | | | |
| Avg | | | | | | | |
| Std Dev | 30.830 | 108.826 | 0.036 | 0.050 | 40.848 | 20.548 | 0.002 |

Note:
“SF” refers to Sugar Free. Jell-O ® brand products may include gelatin, adipic acid, and optionally one or more of disodium phosphate, maltodextrin, fumaric acid, juice solids, such as cranberry juice solids, and a sweetening agent, such as aspartame in sugar free products, or sugar in sugar-added products.

TABLE 2
Rupture Strength and Brittleness properties of Jell-O ® control
sample and Jell-O ® sample containing Fibersol-2.

| | Rupture Strength (G) | Brittleness (Mm) |
|---|---|---|
| Test ID | Force 1 | Distance 1 |
| Jell-O ® Control - Avg | 126 | 5.94 |
| Jell-O ® Control - SD | 18.2 | 0.455 |
| Jell-O ® with Fibersol - Avg | 138 | 7.50 |
| Jell-O ® with Fibersol - SD | 61.0 | 0.953 |

Note:
“SD” refers to Standard Deviation

It was observed that the control sample may have set slightly faster than the Fibersol-containing mixture, but both were set well within the 4 hours specified in the instructions provided on the packaging. No significant sensory attributes were apparent between the two samples, with flavor, texture bite, and melt characteristics being similar.

### Example 2

Tests were performed by adding other soluble fibers at a level to make 2.5 g/serving compared to Fibersol. Maltodextrin and sucrose were added into separate mixes at the same level as Fibersol, and the effects were noted. Considerations included dissolution/solubility characteristics, effects on set/set time and gel characteristics (clarity, strength, puncture). For clarity tests, fluid Jell-O® was loaded into spec tubes, while harden and run % transmittance were performed on a spectrophotometer. The compositions tested were as follows:

### 1) Control—no added fiber;

### 2) Fibersol—2.9 g/serving or 11.6 g/box (5% moisture and 90% non-digestible);

### 3) Inulin—2.9 g/serving or 11.6 g/box (5% moisture and 90% non-digestible);

### 4) Polydextrose—3.1 g/serving or 12.4 g/box (5% moisture and 85% non-digestible);

### 5) Clintose CR 10 (maltodextrin)-2.9 g/serving or 11.6 g/box; and

### 6) Sucrose—2.9 g/serving or 11.6 g/box

TABLE 3
Example 2 Fibersol in SF Jell-O ® Compression Results

| | | Adhesiveness | | | | | |
|---|---|---|---|---|---|---|---|
| Test ID | Hardness G | g · sec | Springiness | Cohesiveness | Gumminess | Chewiness | Resilience |
| Jell-O ® | 1002 | −634 | 0.268 | 0.104 | 105 | 28.4 | 0.015 |
| Control - | | | | | | | |
| Avg | | | | | | | |
| Std Dev | 99.1 | 40.9 | 0.025 | 0.014 | 23 | 8.1 | 0.003 |
| Jell-O ® | 1038 | −635 | 0.3 | 0.109 | 112 | 33.7 | 0.015 |
| Fibersol - | | | | | | | |
| Avg | | | | | | | |
| Std Dev | 192.8 | 58.4 | 0.047 | 0.017 | 23.6 | 8.6 | 0.002 |
| Jell-O ® | 1230 | −638 | 0.283 | 0.111 | 138 | 39.7 | 0.016 |
| Inulin - | | | | | | | |
| Avg | | | | | | | |
| Std Dev | 108.6 | 43 | 0.03 | 0.024 | 33.6 | 13.1 | 0.004 |
| Jell-O ® | 1256 | −660 | 0.278 | 0.096 | 121 | 33.8 | 0.013 |
| Polydextrose - | | | | | | | |
| Avg | | | | | | | |
| Std Dev | 84.8 | 78.1 | 0.027 | 0.013 | 23.7 | 8.5 | 0.002 |
| Jell-O ® | 1176 | −606 | 0.259 | 0.101 | 120 | 31.3 | 0.015 |
| Clintose | | | | | | | |
| CR10 - | | | | | | | |
| Avg | | | | | | | |
| Std Dev | 92.5 | 43.2 | 0.027 | 0.013 | 22.6 | 8.2 | 0.002 |
| Jell-O ® | 1223 | −611 | 0.279 | 0.104 | 127 | 35.6 | 0.014 |
| Sucrose - | | | | | | | |
| Avg | | | | | | | |
| Std Dev | 44.8 | 57 | 0.021 | 0.011 | 10 | 5.3 | 0.001 |

TABLE 4
Example 2 Fibersol in SF Jell-O ® Puncture Results

| | | Brittleness |
|---|---|---|
| | Rupture Strength G | Mm |
| Test ID | Force 1 | Distance 1 |
| Jell-O ® Control - Avg | 177 | 6.8 |
| Jell-O ® Control - SD | 4.3 | 0.246 |
| Jell-O ® Fibersol - Avg | 193 | 6.9 |
| Jell-O ® Fibersol - SD | 15.4 | 0.222 |
| Jell-O ® Inulin - Avg | 193 | 6.8 |
| Jell-O ® Inulin - SD | 14.4 | 0.234 |
| Jell-O ® Polydextrose - Avg | 199 | 6.9 |
| Jell-O ® Polydextrose - SD | 11.6 | 0.13 |
| Jell-O ® Clintose CR10 - Avg | 159 | 6.7 |
| Jell-O ® Clintose CR10 - SD | 6.9 | 0.114 |
| Jell-O ® Sucrose - Avg | 173 | 6.7 |
| Jell-O ® Sucrose - SD | 13.1 | 0.117 |

TABLE 5
Example 2 Fibersol in SF Jell-O ® Clarity Results

| | | | | | Clintose | |
|---|---|---|---|---|---|---|
| | Control | Fibersol | Inulin | Polydextrose | CR10 | Sucrose |
| % | 9.55 | 9.42 | 21.1 | 21 | 9.85 | 9.3 |
| Trans- | | | | | | |
| mittance | | | | | | |
| Avg | | | | | | |
| SD | 1.68 | 1.51 | 0.96 | 1.14 | 0.12 | 0.5 |

All set times in this example were within 4 hrs specified by the package.

Regarding sensory and taste experience, the following was observed:

### 1) Control—normal flavor, good;

### 2) Fibersol—no significant difference from control;

### 3) Inulin—slightly firmer texture to control, slightly off taste (possibly bitter/astringent);

### 4) Polydextrose—firmness/texture similar to control, off taste/flavor;

### 5) Clintose CR10— much firmer mouthfeel/texture to control, no significant difference in taste from control; and

### 6) Sucrose—equal firmness/mouthfeel to control, sweeter than control.

Although the data generated was not tested for statistical significance, results would indicate no significant difference in gel hardness between the control and Fibersol samples. A significant difference (increased hardness) was observed for the inulin, polydextrose and sucrose samples. Marginally stronger (rupture strength; probably not statistically significant) gels were produced in the Fibersol and inulin samples, while the polydextrose sample appears to exhibit a statistically significant higher rupture strength. There appeared to be no significant difference in any of the samples relating to observed gel brittleness. Although the inulin and polydextrose may have produced statistically significant clearer gels, that of Fibersol, Clintose CR10 and sucrose were not significantly different from the control. Set times for all treatments were well within that listed for the product, with the inulin, polydextrose, CR10, and sucrose samples setting faster than the Fibersol and the control sample. The Fibersol sample demonstrated no significant deviation from the control as far as taste and mouthfeel. Both the inulin and polydextrose samples were found to possess a bitter/astringent off-taste, while the sucrose was found to be much sweeter. The inulin and CR10 samples were found to have a firmer texture/mouthfeel relative to the control sample.

### Example 3

This example tested the effects of adding competing soluble fibers in full-sugared Jell-O® at levels to make 2.5 g/serving relative to a Fibersol-containing sample. The tests included adding maltodextrin and sucrose into a Jell-O® mix at the same level as Fibersol. Noted effects included dissolution/solubility characteristics, effects on set/set time, and gel characteristics (e.g. clarity, strength, and puncture). To test for clarity, fluid Jell-O® was loaded into spec tubes and allowed to harden. The samples were then tested on a spectrophotometer for % transmittance. The addition rate for samples was the same as Example 2.

Although statistics were not run on the data, results would indicate that all treatments, with the exception of sucrose, produced harder gels as compared to the control. Most other gel attributes were similar for all treatments, with the exception of gumminess. All treatments, with the exception of Fibersol, were rated as significantly gummier than the control. Stronger (rupture strength; statistically significant) gels were produced in the control and Fibersol samples as compared to other treatments (control vs. Fibersol would not be significantly different). There appeared to be no significant difference in gel brittleness observed in any of the samples. The Fibersol sample exhibited equivalent clarity relative to the control sample. All other samples would be rated as statistically inferior in clarity to the control. Set times for all treatments were well within that listed for the product, with the inulin, polydextrose, CR10, and sucrose samples setting faster than the Fibersol and control samples. The Fibersol sample, as well as the polydextrin sample, demonstrated no significant deviation from the control sample as far as taste and mouthfeel. The inulin sample was found to possess a bitter/astringent off-taste and decreased sweetness, while the sucrose sample was found to be much sweeter. The CR10 and inulin samples were found to have a firmer texture/mouthfeel as compared to the control, CR10 even Brittle. The sucrose treatment exhibited a rough-grainy mouthfeel.

TABLE 6
Example 3 Fibersol in Jell-O ® Compression Results

| | | Adhesive- | | | | | |
|---|---|---|---|---|---|---|---|
| | | Ness | | Cohesive- | | | |
| Test ID | Hardness G | g · sec | Springiness | Ness | Gumminess | Chewiness | Resilience |
| Jell-O ® | 583 | −313 | 0.309 | 0.093 | 54 | 17.3 | 0.051 |
| Control - | | | | | | | |
| Avg | | | | | | | |
| Std Dev | 69 | 114.6 | 0.096 | 0.02 | 9.3 | 8 | 0.056 |
| Jell-O ® | 814 | −273 | 0.354 | 0.069 | 55 | 19.5 | 0.027 |
| Fibersol - | | | | | | | |
| Avg | | | | | | | |
| Std Dev | 146 | 27.1 | 0.033 | 0.011 | 5.8 | 3.7 | 0.012 |
| Jell-O ® | 762 | −593 | 0.297 | 0.113 | 86 | 25.6 | 0.013 |
| Inulin - | | | | | | | |
| Avg | | | | | | | |
| Std Dev | 55.4 | 76.2 | 0.021 | 0.024 | 18.6 | 6 | 0.002 |
| Jell-O ® | 743 | −572 | 0.256 | 0.118 | 88 | 22.8 | 0.015 |
| Polydextrose - | | | | | | | |
| Avg | | | | | | | |
| Std Dev | 67 | 51.2 | 0.03 | 0.016 | 17.8 | 5.7 | 0.003 |
| Jell-O ® | 731 | −579 | 0.298 | 0.14 | 100 | 30.4 | 0.015 |
| Clintose | | | | | | | |
| CR10 - | | | | | | | |
| Avg | | | | | | | |
| Std Dev | 72 | 88.4 | 0.037 | 0.035 | 19.1 | 8.8 | 0.002 |
| Jell-O ® | 619 | −624 | 0.325 | 0.13 | 81 | 26.5 | 0.013 |
| Sucrose - | | | | | | | |
| Avg | | | | | | | |
| Std Dev | 40.9 | 41.1 | 0.046 | 0.014 | 9.6 | 6.6 | 0.002 |

TABLE 7
Example 3 Fibersol in Jell-O ® Puncture Results

| | | Brittleness |
|---|---|---|
| | Rupture Strength G | mm |
| Test ID | Force 1 | Distance 1 |
| Jell-O ® Control - Avg | 145 | 6 |
| Jell-O ® Control - SD | 9.7 | 0.189 |
| Jell-O ® Fibersol - Avg | 132 | 5.9 |
| Jell-O ® Fibersol - SD | 8.9 | 0.168 |
| Jell-O ® Inulin - Avg | 123 | 5.8 |
| Jell-O ® Inulin - SD | 11.2 | 0.05 |
| Jell-O ® Polydextrose - Avg | 118 | 5.6 |
| Jell-O ® Polydextrose - SD | 4.8 | 0.145 |
| Jell-O ® Clintose CR10 - Avg | 106 | 5.4 |
| Jell-O ® Clintose CR10 - SD | 42 | 0.731 |
| Jell-O ® Sucrose - Avg | 108 | 5.6 |
| Jell-O ® Sucrose - SD | 10.5 | 0.247 |

TABLE 8
Example 3 Fibersol in Jell-O ® Clarity Results

| | | | | | |
|---|---|---|---|---|---|
| | | | | Clintose | |
| Control | Fibersol | Inulin | Polydextrose | CR10 | Sucrose |

| | | | | | | |
|---|---|---|---|---|---|---|
| % Trans- | 9.55 | 9.52 | 8.32 | 8.53 | 8.22 | 8.12 |
| mittance | | | | | | |
| Avg | | | | | | |
| SD | 0.08 | 0.16 | 0.12 | 0.1 | 0.08 | 0.08 |

All set times were within 4 hrs. specified by the package.

Regarding sensory and taste experience, the following was observed:

### 1) Control—normal flavor, good;

### 2) Fibersol—no significant difference from control;

### 3) Inulin—slightly firmer texture to control, less sweet than control, slightly off taste (possibly bitter);

### 4) Polydextrose—no significant difference from control;

### 5) Clintose CR10— firmer, brittle mouthfeel/texture than control; slightly off-flavor not defined; and

### 6) Sucrose—extremely sweet, rough-grainy texture & mouthfeel.

While this invention has been particularly shown and described with references to certain embodiments thereof, it will be understood by those skilled in the art that various changes in form and details may be made therein without departing from the scope of the invention encompassed by the claims.

What is claimed is:

1. A food gel, comprising:
a gel forming material present in an amount sufficient to form a food gel matrix; and
an indigestible or poorly digestible carbohydrate-containing ingredient.

2. The food gel of claim 1, wherein the carbohydrate-containing ingredient provides increased dietary fiber content in the food gel relative to a food gel not comprising the indigestible or poorly digestible carbohydrate.

3. The food gel of claim 1, wherein the carbohydrate-containing ingredient is a highly branched soluble fiber.

4. The food gel of claim 1, wherein the carbohydrate-containing ingredient is selected from the group consisting of Fibersol-2, inulin, highly branched maltodextrin, fructooligosaccharides, polydextrose, and mixtures of any thereof.

5. The food gel of claim 4, wherein the carbohydrate-containing ingredient is Fibersol-2.

6. The food gel of claims 1, wherein the gel forming material comprises gelatin in an amount of at least 6% by dry weight.

7. The food gel of claims 1, wherein the gel forming material comprises gelatin in an amount of at least 9% by dry weight.

8. The food gel of claim 1, wherein the food gel is substantially sugar-free and comprises at least 15% by dry weight gelatin.

9. The food gel of claim 1, wherein the food gel is substantially sugar-free and comprises at least 20% by dry weight gelatin.

10. A food gel, comprising:
a gel forming material present in an amount sufficient to form a food gel matrix; and
an amount of Fibersol-2 effective to provide increased dietary fiber content in the food gel relative to a food gel not comprising an amount of Fibersol-2.

11. The food gel of claim 10, wherein the gel forming material comprises gelatin in an amount of at least 6% by dry weight and sugar.

12. The food gel of claim 10, wherein the gel forming material comprises gelatin in an amount of at least 9% by dry weight and sugar.

13. The food gel of claim 10, wherein the food gel is substantially sugar-free.

14. The food gel of claim 13, wherein the gel forming material comprises gelatin in an amount of at least 15% by dry weight.

15. The food gel of claim 13, wherein the gel forming material comprises gelatin in an amount of at least 20% by dry weight.

16. A food gel composition, comprising the food gel of claims 1.

17. A food gel, comprising:
a gelatin in an amount of at least 6% by dry weight;
adipic acid;
Fibersol-2;
optionally, a sweetening agent;
optionally, disodium phosphate;
optionally, maltodextrin; and
optionally, fumaric acid.

18. The food gel of claim 17, wherein the gelatin is present in an amount of at least 9% by dry weight.

19. The food gel of claim 17, wherein the gelatin is present in the range of 15% by dry weight.

20. The food gel of claim 17, wherein the sweetening agent is sugar
